(19) United States
(12) Patent Application Publication
(10) Pub. No.: US 2026/0074503 A1
(43) Pub. Date: Mar. 12, 2026

(54) Cable Sealing Housing and Method for Producing Such a Housing

(71) Applicant: FIT Voltaira Autokabel Gruppe GmbH, Pfullingen (DE)

(72) Inventors: Sebastian Martens, Straelen (DE); Ralf Bodem, Meerbusch (DE); Oliver Wenzel, Düsseldorf (DE)

(21) Appl. No.: 19/107,304

(22) PCT Filed: Sep. 21, 2022
(86) PCT No.: PCT/EP2022/076213

§ 371 Date: Feb. 27, 2025

(51) Int. Cl. H02G 15/117; H02G 1/14; H02G 15/00; H02G 15/113

(52) U.S. Cl. CPC H02G 15/117; H02G 1/14; H02G 15/003; H02G 15/113

(57) ABSTRACT

The invention relates to a cable-sealing arrangement having an at least two-part housing with an upper part and a lower part, and at least one opening formed as a cable-entry point in the housing, wherein the upper part and the lower part each form one part of the openings, characterized in that, when the housing is in the joined state, abutting joining surfaces of the upper part and lower part have been laser-welded to one another.

The subject matter relates to a cable sealing housing and a method for producing such a housing.

In the automotive industry, electrical wiring is safety-relevant. Since vehicles are generally exposed to varying environmental conditions, such as rain, splash water, road salt, extreme temperature fluctuations and the like, electrical connections are always potential sources of failure, particularly with regard to leakage currents, short circuits, and/or corrosion. In particular for battery cables, which may also be permanently connected to the battery positive potential, contact corrosion can be promoted by the voltage applied to the cable.

Connections between two electrical cables are typically implemented using a cable lug and/or appropriate screw connections. In this context, it is important that the connection point is protected against moisture penetration. Nowadays, this is usually achieved by using a shrink tube with an internal adhesive layer, which is pulled over the connection point and then shrunk. However, such a shrink tube, especially in conjunction with silicone-coated cables, presents challenges with regard to longitudinal water, which can seep between the shrink tube and the cable insulation. Achieving complete sealing is hardly possible in such cases.

Especially for battery cables or other high-voltage applications in the automotive industry, the fording depth is also a relevant criterion. Vehicles may only be submerged in water to a certain depth, which is referred to as the fording depth. The installation of battery cables below the floor of the vehicle may result in the cables being below the vehicle's fording depth. In particular, there is a risk that electrical cables that are installed below the vehicle floor and immersed in water could suffer permanent damage.

Underfloor installation and/or installation outdoors always present a particular challenge with regard to the ingress of moisture. However, due to electrification of the drive train, cables are increasingly being laid under the floor and/or outside, particularly outside the passenger compartment. In this case, and particularly in high-voltage applications, especially at voltages of 48V and above, and especially at voltages of more than 300 V, the connection between the cables must be specially protected against the ingress of moisture. In particular, longitudinal water must be prevented from causing leakage currents or short circuits.

In particular, the sealing of center taps, where a branch cable splits off from the middle of a main cable, is only possible using an expensive Y-shrink tube, and the manufacturing effort required to thread the cables into such a tube is immense. Moreover, the sealing performance, which is particularly dependent on the insulation material of the cables, is sometimes inadequate, especially in the case of silicone-coated cables. In addition, the permissible ambient temperature for the use of such systems is limited by the melting temperature of the adhesive layer.

In addition to the costly shrink tubing, there is the option of protecting the connection against water using a housing. However, sealing the housing always presents challenges.

The problem addressed by the subject matter was therefore that of protecting the connection between at least two electrical cables within a motor vehicle against moisture. This problem is solved using a cable sealing housing according to claim 1.

A cable sealing housing may also be referred to as a sealing housing, casing, enclosure or the like.

First, a two-part housing is proposed. Such a housing is formed of at least one upper part and at least one lower part. The terms “above” and “below” describe the relationship of the two parts to each other. An upper part can also be referred to as a first part, and a lower part can be referred to as a second part. Conversely, an upper part can also be referred to as a second part, and a lower part can be referred to as a first part.

The upper and lower parts may each be shell-shaped and, in the joined state, form the housing. In the joined state, the connection between two cables or a cable and a connecting bolt or another connecting part is formed within the housing. A cable may either be a connecting cable or a main cable or vice versa. The terms “main cable” and “branch cable” are used to linguistically distinguish these two cables from each other. The cables themselves can be essentially the same, identical or similar to each other. When a branch cable is mentioned, this always also encompasses a connecting part, connecting bolt, connecting piece, connecting lug, connecting part or the like. What these parts have in common is that they can be electrically connected to the main cable, and that at least one electrically conductive part, preferably covered by an insulating material, is led out of the housing. When a main cable is mentioned, this always also encompasses a connecting part, connecting bolt, connector, connecting lug, connecting part or the like. What these parts have in common is that they can be electrically connected to the connecting cable at a center tap, and that at least two electrically conductive parts, preferably covered by an insulating material, are led out of the housing.

The two-part design of the housing, in particular the upper part and the lower part, has the advantage that the housing can be positioned at any point along the cable harness, including in the region of a center tap. A center tap can be implemented at any point along the main cable and sealed by the housing in question.

The previous and following statements regarding the seam and the gap primarily refer to the region of the cable-entry point of the housing. The following features apply accordingly, particularly in the region of the seam and the gap in the region of the cable-entry point, also referred to as the opening. However, the features may also refer to additional regions, in particular all regions of the seam and the gap between the housing parts.

The advantage of the two-part housing is also that after connecting the main cable with the branch cable, this connection can be placed into the lower/upper part, after which the second part of the housing is placed on top and the closed housing is sealed. The laborious task of threading the connection into a Y-shrink tube is eliminated.

A fully pre-assembled cable with the main cable and branch cable can simply be placed into one of the two parts of the housing, the housing can then be closed by joining this one part to the other part of the housing, and the two parts can subsequently be welded together. Of particular interest is that the seam between the two housing parts is sealed. Also of particular interest is that, in the region of the cable-entry point, longitudinal water does not enter the housing along the seam between the two housing parts.

In the housing there is at least one opening formed as a cable-entry point, also referred to as a cable-entry point. The opening is used to guide the cable into the housing. Preferably, the opening is formed in a region between the upper part and the lower part. When the housing is in the joined state, the opening may be located partly in the upper part and partly in the lower part. For example, if the upper part is placed on the lower part, the side walls of the upper and lower parts are in abutment against each other. In one region of a wall, the upper part and the lower part each comprise a recess which forms part of the opening when the housing is in the joined state. In the region of this opening, the cable is either guided out of or into the housing.

The seam between the two housing parts is of particular importance in the region of the inner lateral surface of the cable-entry point. The cables, along with their insulation, lie directly on the sealing element or the inner lateral surface of the housing; if a sealing element is present, it lies on the inner lateral surface of the housing. Moisture could penetrate into the housing via a gap running along the length of the cable/sealing element in the region of the seam. Therefore, it is necessary to prevent such a gap. This is achieved, in connection with the subject matter, by filling the gap with molten material produced during the welding process, particularly in the region of this inner lateral surface. To ensure that the gap is completely closed, it is preferred for the molten material to form a bead that extends beyond the gap and into the interior of the cable-entry point.

In order to seal the housing, it is now proposed that the abutting joining edges of the upper and lower parts are welded together when the housing is in the joined state. The upper and lower parts are thereby welded together to be particularly moisture-tight, but preferably also gas-tight. When joined, the upper and lower parts are directly in abutment against each other with their joining edges. The materials of the upper and lower parts can be melted and joined together by means of laser welding. The materials are mainly plastics, in particular, thermoplastics. PA6 or PA6.6 with optional glass fiber content between 15-30 wt. % or vol. % are preferred.

The cable-sealing arrangement in question is particularly suitable for a cable branch at a center tap of a main cable. A main cable may be stripped at a center tap. On either side of this stripped region, the main cable extends with an insulating sheath. The material of the insulating sheath of the main cable and/or the branch cable can be silicone. The material of the insulating sheath can also be PVC.

For the purpose of joining the two housing parts, these are provided with mutually facing joining surfaces. It has been found advantageous if a first joining surface is a flat surface and the second joining surface has a rib. The first joining surface can be formed by an end face of an edge of one of the housing parts. The first joining surface preferably extends perpendicular to an outer wall and/or an inner wall of the housing.

The second joining surface is initially arranged corresponding to the first joining surface on the other housing part. In contrast to the first joining surface, the second joining surface is not flat but has a rib. The rib is a projection on the joining surface. The rib in this case preferably has a rectangular cross-section. The rib may also have a conical cross-section, in particular tapering from the base towards its end wall.

In a cross-section, the first joining surface has a greater width than the end face of the rib. The rib abuts the first joining surface with its end face. Along each side of the rib's sidewalls, the first joining surface extends in a flat region. On the inner side wall of the rib, the first joining surface preferably extends completely level to the inner wall of the housing. On the outer side wall of the rib, the first joining surface also preferably extends completely level to the outer wall of the housing. However, it is also possible for the first joining surface to transition towards the second joining surface in the manner of a fold or a collar.

Starting from the second joining surface, the rib has two opposing side walls and an end wall. The side walls preferably run parallel to each other. The end wall preferably runs perpendicular to at least one side wall. The end wall of the rib faces the first joining surface during the joining process. The end wall of the rib runs parallel to the first joining surface during the joining process. The rib has a height of less than 1 cm, preferably less than 2-5 mm. The rib preferably has a height of 1 mm. The width of the rib, i.e., the distance between the side walls of the rib, is preferably equal to the height of the rib.

The rib causes a gap to form between the two joining surfaces. The rib acts as a kind of spacer between the joining surfaces. If the first joining surface abuts the rib, the base (root) of the rib is spaced from the abutting surface by the gap. This gap must be sealed. For this reason, it is proposed that laser welding be used to melt a region of the rib facing the first surface and at least partially fill the gap between the mutually facing joining surfaces with molten material from the rib. Preferably, the material of the rib is heated and melted by the laser. The temperature of the molten material subsequently causes the material of the first joining surface in the region of the rib to melt. Consequently, material from the first and second parts melts preferentially, filling the gap. Furthermore, as a result of melting the material of both joining surfaces, the two housing parts are welded together after cooling.

In laser welding, the laser is preferably guided through the material of the first part. In particular, the laser beam passes through the material of the first part, exits the first joining surface, and strikes the rib, in particular the end face of the rib. Preferably, the laser is guided along the longitudinal direction of the rib. The laser is preferably guided several times with a spatial offset in the radial direction (i.e., from the inside to the outside or from the outside to the inside of the housing) along the longitudinal direction of the rib. The laser is guided over the rib at an offset in a sufficiently short time to melt the material of the rib's end face over its entire area. The laser irradiates the surface almost simultaneously, such that this process is referred to as quasi-simultaneous welding.

The material of the first part is preferably different from the material of the second part. It is also preferred that the melting point of the material of the first part is equal to the melting point of the material of the second part. It is also possible that the material of the rib is different from the material of the first joining part. It is also possible that the material of the rib is different from the material of the second joining part. Preferably, the rib and the second joining part are formed integrally and/or made of the same material. The material of the first part and/or the rib differs from the material of the second part, particularly with regard to its optical properties. In particular, the material of the second part and/or the rib absorbs the radiation energy of the laser to a higher degree than the material of the first part.

According to one exemplary embodiment, it is proposed that, through laser welding, a region of the first surface that directly abuts the rib is melted, and that the molten material at least partially fills the gap between the mutually facing joining surfaces. The laser beam is adjusted so that it strikes the surface of the second joining surface in the region of the rib, in particular the end face of the rib. The material of the rib and/or the second part is such that the radiation energy of the laser beam is sufficient to heat the material above its melting point/melting temperature at normal pressure. The melting temperature is preferably reached after less than 2 seconds, preferably less than 1 second, during laser irradiation. The material melts and liquefies. The molten material flows into the gap, formed by the rib, between the first and second joining surfaces. It is understood that, after welding, the gap is at least partially closed by the molten and resolidified material. After welding, the molten material is located in the gap. Since a contact force presses the two parts together during welding, the molten material is forced into the gap. The width of the gap is reduced due to the melting of the rib material and the contact force.

According to one exemplary embodiment, it is proposed that the molten material of the first surface and the molten material of the rib form an integral bond and at least partially fill the gap between the mutually facing joining surfaces. The energy input of the laser onto the second joining surface causes it to heat up. The temperature may be sufficient to also reach the melting point of the material of the first joining part adjacent to the rib. As a result, the material of the first part and the second part is melted in the region of the joining surface and the molten materials combine to form a single melt. This melt flows, as described above, in the gap. After the joining surface is no longer exposed to the laser beam, the melt cools and solidifies, and the first part is integrally bonded to the second part via the melt.

According to one exemplary embodiment, it is proposed that the molten material fill the gap between the mutually facing joining surfaces essentially only in the region of an inner wall of the housing. The geometry of the two joining surfaces and the arrangement of the rib are preferably designed such that the melt fills the gap between the mutually facing joining surfaces only in the region of an inner wall of the housing. The rib is positioned within the second joining surface, with individual distances between its side walls and an inner wall and an outer wall of the housing, as well as of the first and second parts. The arrangement is such that the molten material (the melt) flows preferentially and/or initially into the region of the gap between the two parts that is on the inside of the housing. As a result, this gap is preferentially first closed. Particularly in the region of the opening, the gap extends in the longitudinal direction of the opening, running from the outer wall towards the inner wall of the housing, parallel to the rib. Through this gap, longitudinal water can penetrate into the interior of the housing. The described preferential filling of the gap in the interior ensures that this region of the gap is securely sealed. Preferably, a quantity of material from the rib and/or the first part is melted such that the volume of the melt is at least equal to, preferably greater than, the volume of the gap between the inner side wall of the rib and the inner wall of the housing.

According to one exemplary embodiment, it is proposed that a displacement path of the rib caused by the laser welding is greater than 0.1 mm, preferably greater than 0.2 mm, and less than 0.5 mm, preferably less than 0.4 mm. As already mentioned, the laser welding melts at least the material of the rib. During laser welding, the first part is pressed against the second part with a force. The force is applied at an angle to the joining surfaces, in particular at a right angle. Due to the force applied during the melting process, the rib shifts by a certain amount or displacement path. It is preferable for the displacement path to be set as described. This means that on the one hand, enough material is melted to fill the gap adequately, and on the other hand, part of the rib remains unmelted. This ensures that the melt flows into the gap in the desired manner.

According to one exemplary embodiment, it is proposed that, in a cross-section through the second joining surface, the rib is arranged off-center, in particular offset in the direction of an inner wall of the housing, in particular that a spacing from an inner side wall of the rib to an inner wall of the housing is smaller than a spacing from an outer side wall of the rib to an outer wall of the housing. Positioning the rib closer to the inner wall of the housing than to the outer wall ensures that the molten material from the rib completely closes the gap between the rib and the inner wall of the housing.

The described arrangement is preferred in the region of the cable-entry point.

Preferably, the rib is located in the middle of the region outside the cable-entry point or even in the surrounding collar of the second joining surface. This improves accessibility for the laser.

It is preferred if the rib is arranged off-center and offset inwardly in the region of the cable-entry point. Furthermore, it is preferred if the rib is also arranged off-center in the region of the remaining housing, i.e., in the region not affecting the cable-entry point, but different from the region of the cable-entry point. In particular, the rib may be positioned further outwards there. In the region of the cable-entry point, the arrangement towards the center is advantageous in order to seal the longitudinal gap. In the region away from the cable-entry point, the arrangement is offset outwards to close an external gap.

The laser preferably strikes the end surface of the rib off-center on this end face. In particular, the laser strikes the end face of the rib further towards the inner wall of the housing. As a result, the rib initially melts in this inner region, and the melt is directed towards the inner wall of the housing.

The laser is preferably guided over the entire end face of the rib in rapid succession. In particular, the laser is guided quasi-simultaneously along the end face of the rib. The laser is guided radially over the end face in the shortest possible time sequence, allowing the entire end face to melt.

According to one exemplary embodiment, it is proposed that the material melted by the laser welding completely fill the gap between the housing parts, starting from the rib towards an inner wall of the housing, in particular that the melted material has a bead pointing into the interior of the housing. As already described, the region of the gap between the rib and the inner wall of the housing is critical with regard to longitudinal watertightness. It is therefore proposed to melt a volume of material sufficient to completely fill the gap, at least in this region. In particular, more material is melted, so that an inwardly projecting bead forms on the inner wall of the housing, especially in the region of the opening. However, the bead is small enough to ensure that the sealing ring described below provides sufficient sealing.

The sealing ring is preferably made of a particularly soft and temperature-resistant material. Silicone or rubber are preferred for this purpose. However, the insulation can vary. Typical materials are silicone, PVC or PUR. EPDM, XLPE/XLPO, PA11/PA12 are also possible options. If an insulating sheath made of silicone is used, the sealing ring is preferably also made of silicone.

In the stripped region, the bare metal of the cable core is mechanically and electrically connected to a branch cable, preferably with its bare metal at an end that is also stripped. The connection can be, in particular, force-fitting, form-fitting and/or integral. The connection can, in particular, include crimping, soldering and/or welding. The branch cable can, in particular, be formed as a splice.

The two cable ends of the main cable extending from the stripped center tap protrude from two openings in the housing, and the end of at least one branch cable extending away from the center tap protrudes from at least one third opening in the housing. More than 2 cables can also be welded together to form a “star.” The background would be, for example, that different insulation materials are used in a line harness. This makes it possible to create a modular structure tailored to specific requirements.

Main cables and branch cables can be connected to each other in a first method step. For example, an region in the middle of the main cable can first be stripped. One end of a branch cable can also be stripped. A stripped end of a branch cable can be placed on the bare metal of the main cable exposed after stripping. Main and branch cables can be connected to each other using their metallic strands.

This is possible, for example, by means of ultrasonic welding, laser welding, resistance welding, friction welding or the like.

Main cables and branch cables can be constructed either as stranded conductors with multiple strands or as solid conductors with a single strand made of solid material. In particular, the main cable can also be designed as a flat conductor rail from which the branch cable branches off. The main cable can also have a round or, in the case of a flat conductor rail, a square conductor cross-section. The branch cable may preferably have a round conductor cross-section.

After the cables are joined, they can be placed into the upper or lower part, and the cable harnesses can be inserted into the recesses provided in the side walls. Subsequently, the corresponding upper/lower part can be mounted, with the recesses arranged over the cable harnesses. The openings formed by the upper and lower parts completely surround the cable harnesses, in particular the insulation sheaths of the cables.

According to one exemplary embodiment, it is proposed that the cables be arranged in an insulated manner in the region of each opening on the housing. In this case, insulation is achieved by placing a sealing ring between the insulation sheath of the cable and the housing. An inner lateral surface of the sealing ring lies against the insulating sheath of the cable and an outer lateral surface of the sealing ring lies against the inner wall of the housing in the region of the opening.

It is advisable to first put two sealing rings on the main cable and arrange them on both sides of the center tap. The insulation of the center tap can be removed either before or after this step. Another sealing ring can be pushed onto the end, also stripped, of the branch cable. This can also be done before or after stripping. When the insulation is removed, the insulating sheath can be cut open using a laser or a knife, for example.

The sealing ring is preferably made of a plastic that is softer than the material of the housing and can be referred to as a soft component. The sealing ring is particularly made of an elastomer, EPDM, silicone or rubber.

The sealing ring can, for example, have a core made of a hard component and outer lateral surfaces made of the soft component. The soft component can enclose the core circumferentially. It is also possible for the sealing ring to be formed from a hard component and a soft component along its longitudinal axis. However, the sealing ring can also preferably be formed only from the soft component.

According to one exemplary embodiment, the hard component can be glued or welded to the housing. This allows an integrally bonded joint zone to be created between the inner surface of the opening and the hard component, extending all around and forming a sealed connection.

Preferably, however, the soft component is in abutment all around the insulation of the cable and around an inner lateral surface of the opening. Due to an elastic deformation of the sealing ring, it acts as a seal against longitudinal water.

The cable is movably mounted in the opening. In order to prevent liquid tightness defects from occurring due to axial movements of the cable, it is proposed that the sealing ring be formed with lamellae on at least the inner surface, but preferably also on the outer surface. In this case, at least two, but preferably more, axially spaced apart, radially protruding, preferably completely circumferential lamellae can be provided. A lamella on an outer surface is formed from a region projecting radially further outwards and a region projecting radially less outwards. A lamella on an inner surface is formed from a region projecting radially further inwards and a region projecting radially less inwards. The lamellae on the outer surface are preferably suitable for sealing the bead formed by welding. It is preferred that the radial extension of the lamellae relative to the opening is greater than the radial extension of the bead. Preferably, the radial extension of the lamellae is greater than the radial extension of the bead by a factor of at least 2, preferably at least 5 or at least 10, preferably between 2 and 10, preferably a maximum of 10.

In a longitudinal section, the lamellae can have a triangular, truncated conical, curved, or similar shape. In this case, regions that project radially further outwards can alternate with regions that project radially further inwards.

According to one exemplary embodiment, it is proposed that the sealing ring be bellows-shaped. This allows the sealing ring to compensate for movements along the longitudinal axis of the cable while maintaining its sealing capability.

According to one exemplary embodiment, it is proposed that the sealing ring be oversized relative to the opening. Thus, in the joined state, the sealing ring is elastically compressed in the radial direction between the housing and the cable. The inner diameter of the sealing ring is preferably smaller than the outer diameter of the cable with insulation sheath. The outer diameter of the sealing ring is preferably larger than the inner diameter of the opening in the assembled state of the housing. The sealing ring is thus slid onto the cable and elastically stretched in the process. When the sealing ring is inserted into the opening and the housing is closed, the sealing ring is preferably elastically compressed. As a result, the sealing ring is elastically compressed in the joined state.

The first joining surface can be flat, and the second joining surface can comprise the rib. The end face of the rib can be flat and lie flush on the first joining surface.

Welding can then take place particularly in the region of the joining surfaces assigned to each other. The welding process is initiated at these joining surfaces that are in contact with each other.

In this context, it is particularly preferred if the materials of the upper and lower parts (first and second parts) exhibit different optical properties, in particular opacities. It is particularly preferred if the housing part comprising the first joining surface has a lower opacity than the housing part comprising the second joining surface with the rib or only the rib. A laser can then pass through the first part to the joining surface of the second part, heating the materials at this transition between the two housing parts and welding them together.

In order to completely close the housing, it is proposed that the rib, with the exception of at least one opening, be completely circumferential and then that the two housing parts be completely welded together in the manner described. The opening is sealed using the described seal.

The opening extends in an axial direction from the inside of the housing to the outside. In this case, the opening preferably protrudes axially outwards from the housing. The rib can run along the axial extension of the opening, in particular parallel to it.

The material of the first and second parts is chosen such that their melts combine and are moisture-tight after solidification.

According to one exemplary embodiment, it is proposed that the sealing ring be mounted between two axially spaced stops which are arranged on the inner lateral surface of the housing and are at least partially circumferential. A stop can be formed by a projection pointing radially inwards in the region of the opening. The projection can be at least partially circumferential. Two axially spaced stops can support the sealing ring axially in the opening. The stops form an inner width that is smaller than the outer circumference of the sealing ring. It is preferred that a stop is arranged in both the upper part and the lower part, each of these stops forming a partially circumferential stop in the joined state. In the assembled state, the sealing ring cannot slip axially beyond one of the at least partially circumferential stops. The sealing ring is preferably axially compressed and mounted between the stops. The axial extension of the sealing ring is preferably at least partially greater than the axial distance between the at least partially circumferential stops so that when the sealing ring is inserted between the stops, it is axially compressed.

According to one exemplary embodiment, the hard component is radially surrounded on both sides by the soft component. In the axial direction, the hard component protrudes beyond the soft components. In the assembled state, this hard component protrudes outwards beyond the opening. In the overhanging region, the hard component encloses a projection forming the opening on an outer surface. This enclosing region of the hard component can engage with locking means on the outer circumference of the projection forming the opening, in particular relative to the axial direction.

An axial direction is defined by an insertion direction of the cable into the opening. The axial direction can thus be understood in particular as a direction that runs transversely, preferably substantially at right angles to the outer surface in which the opening is formed. The axial direction is in particular parallel to the surface normal of the surface in which the opening is formed when the housing is in the joined state.

A radial direction runs perpendicular to the axial direction. The radial direction is preferably the extension direction of the opening. The radial direction preferably extends outwards from a center of the opening. The opening can be oval, right-angled, rectangular, round or the like. The opening is particularly adapted to the cable cross-section, which can be rectangular for a flat cable or round for a round cable.

A further aspect is a method according to claim 24.

Laser welding is preferably carried out using a diode laser. Due to the plastics selected, the radiation output is such that a diode laser is sufficient. The diode laser is particularly suitable for industrial production due to its long service life and low power consumption.

According to one exemplary embodiment, it is proposed that during laser welding, a laser beam strikes the joining surfaces at an angle, in particular that the laser strikes the joining surfaces substantially parallel to a surface normal of the first and/or second joining surface. The laser is preferentially directed through the first part, exits the first joining surface, and strikes the second joining surface.

According to one exemplary embodiment, it is proposed that during laser welding the laser passes through the first joining surface and strikes the rib of the second joining surface. As a result, this melts the material of the rib first.

According to one exemplary embodiment, it is proposed that during laser welding the laser is focused in such a way that the surface of the rib facing the first joining surface is melted first. This ensures that the laser's radiation power is preferentially concentrated on the end face of the rib, causing it to melt first.

According to one exemplary embodiment, it is proposed that the joining surfaces are pressed against each other using a contact force during laser welding, wherein the contact force runs substantially parallel to a surface normal of the first and/or second joining surface. Pressing them together ensures that when the rib is melted, the two parts move towards each other perpendicular to their joining surfaces along the displacement path of the rib. The contact force ensures that the melt fills the gap and that the two parts of the housing are joined together when it cools.

According to one exemplary embodiment, it is proposed that the contact force exceeds 1000 N, preferably 2000 N, in particular 3000 N and/or that the contact force is less than 5000 N, in particular less than 4000 N. It has been shown that this contact force ensures that the melt flows correctly in the gap and that, after cooling, the gap is sealed by the cooled melt. Preferably, the contact force is adjusted depending on the width of the rib, so that sufficient contact pressure is provided.

According to one exemplary embodiment, it is proposed that, during laser welding, the joining surfaces are exposed to the laser for a duration of more than 2 s, preferably between 3 s and 3.5 s, and/or that the joining surfaces are exposed to the laser for a duration of less than 5 s, preferably less than 4 s, during laser welding. This duration ensures, on the one hand, that sufficient material of the rib and the first joining surface melts and, on the other hand, that the rib is still present after welding.

The subject matter is explained in more detail below with the aid of a drawing showing embodiments. In the drawing:

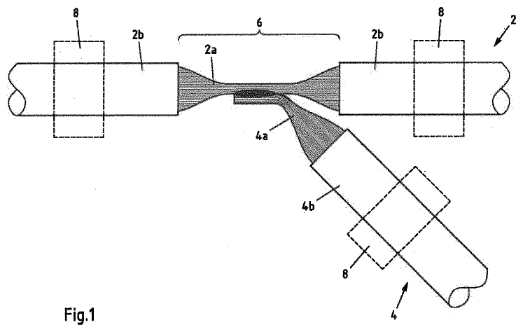

FIG. 1 shows a center tap as a splice;

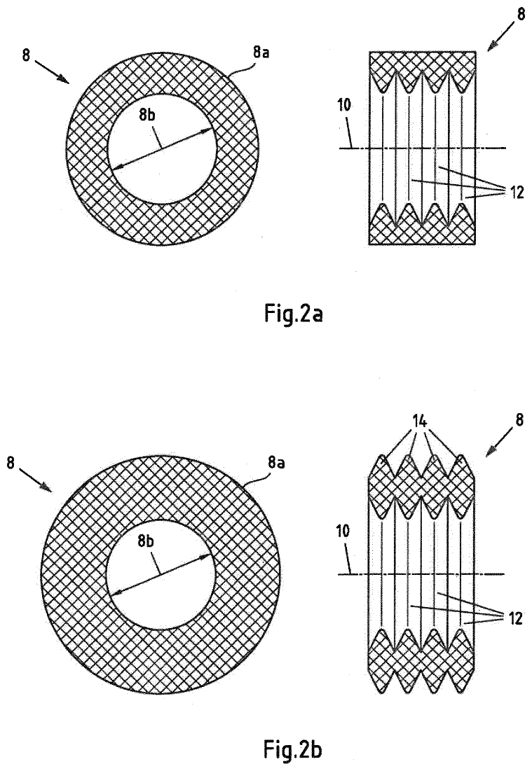

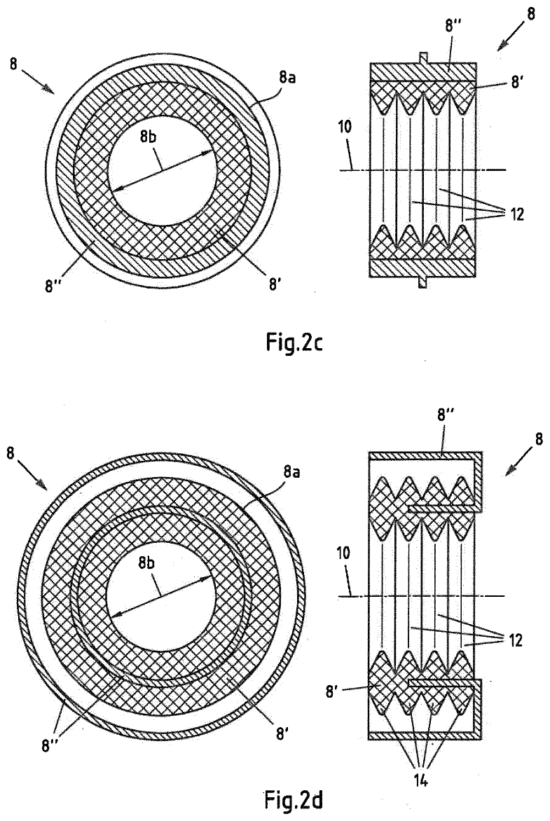

FIG. 2a-d show various exemplary embodiments of sealing rings;

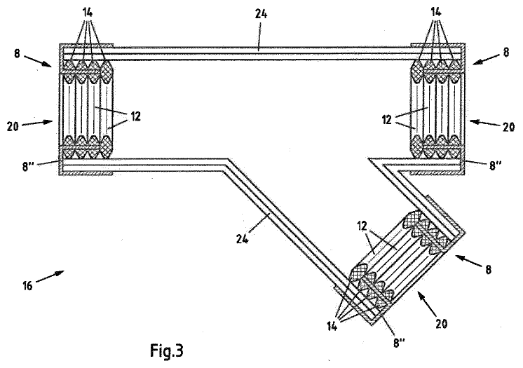

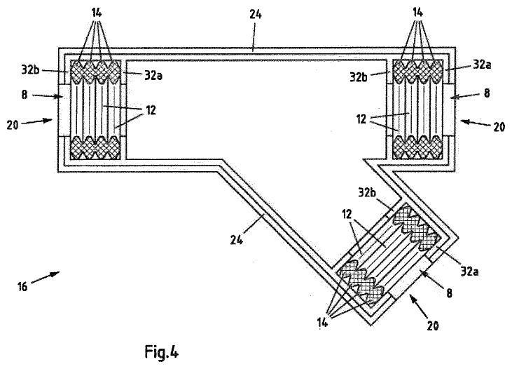

FIG. 3 shows the arrangement of a sealing ring in a cable housing according to an exemplary embodiment;

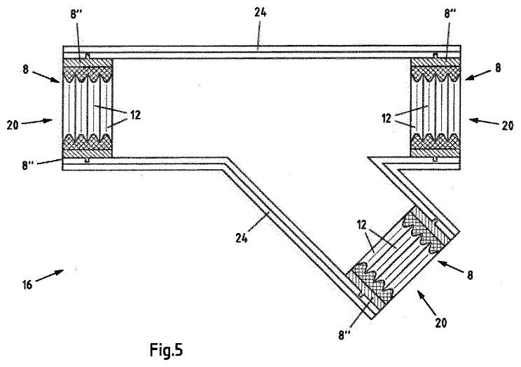

FIG. 4 shows the arrangement of a sealing ring in a housing according to an exemplary embodiment;

FIG. 5 shows the arrangement of a sealing ring in a housing according to an exemplary embodiment;

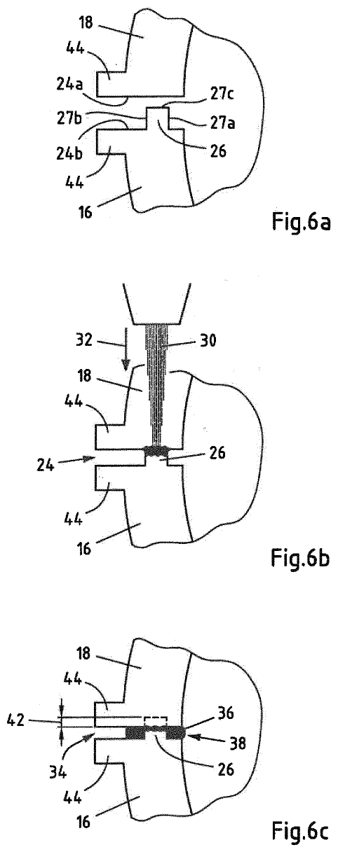

FIG. 6a shows a cross-section through the two housing parts before laser welding;

FIG. 6b shows a cross-section through the two housing parts during laser welding;

FIG. 6c shows a cross-section through the two housing parts after laser welding;

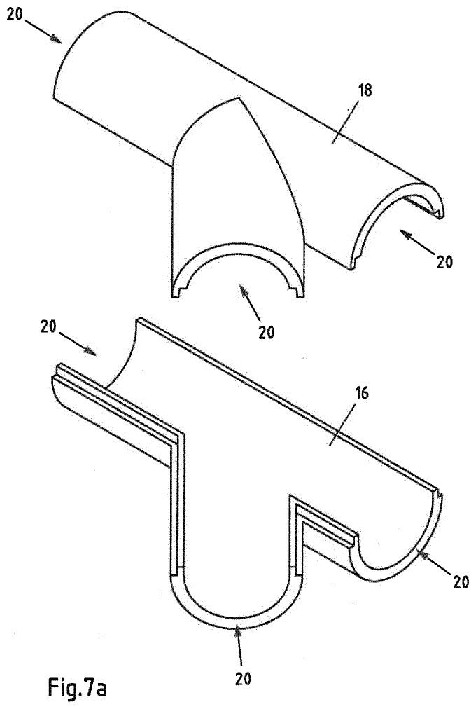

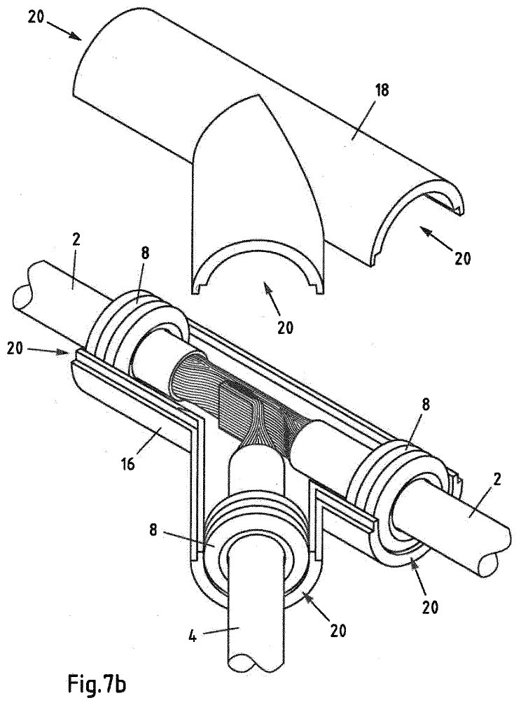

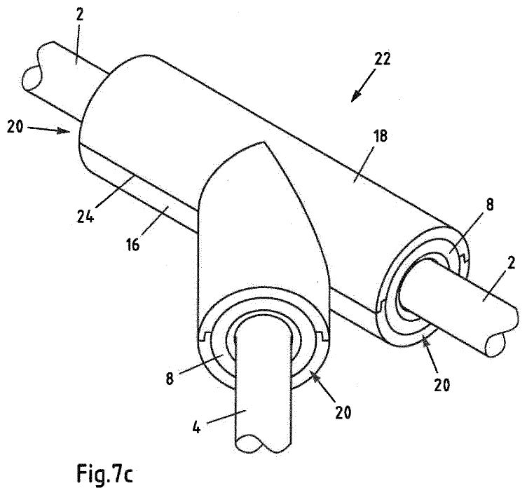

FIG. 7a-c show views of a housing according to an exemplary embodiment;

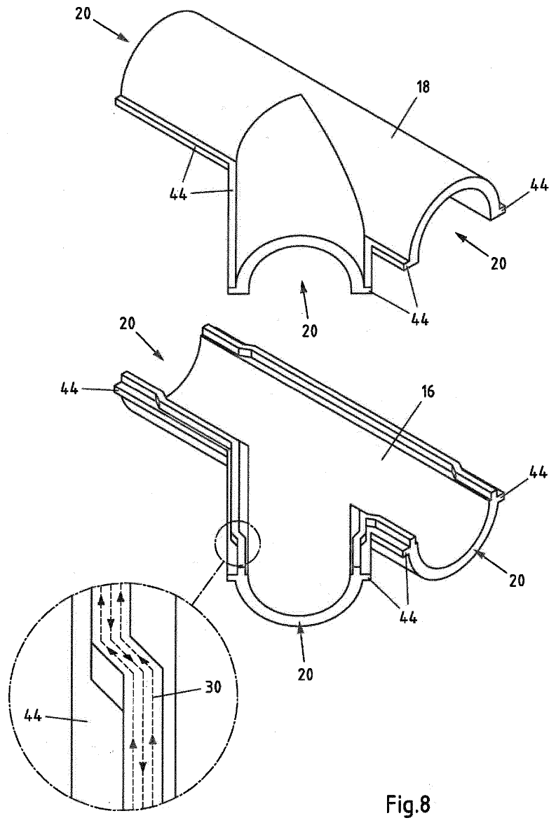

FIG. 8 shows a view of a housing according to an exemplary embodiment.

FIG. 1 shows a connection between two cables. A main cable 2 is connected to a branch cable 4. The two cables 2, 4 are formed from a cable core 2a, 4a and an insulation sheath 2b, 4b.

The cable cores 2a, 4a are made of a metallic material, in particular copper or copper alloy and aluminum or aluminum alloy. The main cable 2 is stripped in a central region 6, i.e., the insulation sheath 2b is removed from the cable core 2a. This can be done in particular by removing the insulating sheath 2b by means of a laser, in particular by cutting open the insulating sheath 2b by means of a laser. Starting from the region 6, the cable 2b extends with two cable ends.

At the cable core 2a in region 6, the cable core 4a of the branch cable 4 is connected. In particular, an integral bond is formed. Soldering or welding is particularly feasible in this case. However, it is also possible to provide a clamping connection, especially in the form of a crimp. The connection is preferably formed as an integral bond by welding, in particular by means of friction welding, preferably by means of ultrasonic welding or by means of resistance welding. The cable cores 2a, 4a are thus mechanically and/or electrically connected to each other.

At the branch cable 4, the cable core 4a is exposed at a cable end. The other end of the cable 4 extends away from the region 6. A connection shown here between a main cable 2 and a branch cable 4 can also be referred to as a splice.

Spaced apart from the region 6, a sealing ring 8 can be provided on the cable 2 at each of the two cable ends. Spaced apart from the region 6, a sealing ring 8 can be provided on the cable 4. The sealing ring 8 is described in more detail below.

During production, two sealing rings 8 can be pushed onto the main cable 2 at a distance from the region 6. Before or after this step, the insulating sheath 2b can be removed from the region 6. Subsequently, a stripped cable end of the branch cable 4 is connected in the region 6 with its cable core 4a to the cable core 2a in the manner described above. Before or after this step, a sealing ring 8 can be pushed onto the branch cable 4. A connection is formed between a main cable 2 and a branch cable 4, wherein a sealing ring 8 is pushed in each case onto the respective insulation sheaths 2b, 4b at a distance from the connection at the outgoing cable ends. Such a connection between two cables can be protected against moisture as described below.

A sealing ring 8 to be pushed onto the insulating sheaths 2b, 4b is shown as an example in FIG. 2a-d. A cross-section and a longitudinal section through a sealing ring 8 are shown.

In FIG. 2a, it can be seen in cross-section that the sealing ring 8 has an outer circumference 8a and an inner width 8b. The inner width 8b is, particularly in its profile, geometrically similar to the cross-sectional profile of the cables in question 2, 4, and is preferably round or rectangular.

In a longitudinal section through the sealing ring 8, it can be seen that said sealing ring comprises lamellae 12 spaced apart from one another along the axial axis 10 in the region of its inner lateral surface. The lamellae 12 are formed by regions projecting radially further inwards and regions projecting radially less inwards. Radial is a direction perpendicular to the longitudinal axis 10. The lamellae 12 are preferably circumferential to a central axis which runs along the longitudinal axis 10.

When the sealing ring 8 is pushed on, the lamellae 12 lie with their radially inwardly projecting regions on the insulating sheath 2b.

For sealing against the housing, it is preferred that, in addition to the lamellae 12, lamellae 14 are also provided on the outer circumference 8a, as shown in FIG. 2b. The lamellae 14 can be formed in a manner similar to the lamellae 12 and have regions projecting radially further outwards and regions projecting radially less outwards. In the installed state, the regions projecting further radially outwards rest against the inner wall surfaces of the opening in the housing.

FIG. 2c shows a sealing ring 8 consisting of a soft component 8′ and a hard component 8″. The sealing rings 8 according to FIG. 2a and b, which are formed only from the soft component 8′, are additionally supplemented, according to FIG. 2c and d, by a hard component 8″. According to FIG. 2c, the hard component 8″ is provided on the outer circumference of the sealing ring 8. In the longitudinal section according to FIG. 2c it can be seen that the lamellae 12, as previously described, are provided on an inner circumference.

A ring made of a hard component 8″ is in abutment all around the outer circumference 8a of the sealing ring 8. This ring may include a circumferential projection in the form of a welding lug. In the joined state, this projection can rest against the inner lateral surface of the housing and be welded there in a manner described above for the joining surfaces. The hard component 8″ is preferably made of the same material as the top or bottom of a housing.

FIG. 2d shows another exemplary embodiment of a sealing ring 8. In this sealing ring, the hard component 8″ is led from an axial end face of the sealing ring 8. The hard component 8″ preferably encloses the soft component 8″ on the outer circumference 8a of the sealing ring 8. The lamellae 12, 14 are provided as shown in FIG. 2b.

The part of the hard component 8″ with a U-shaped cross section encloses the outer housing wall in the joined state, thus fixing the sealing ring 8 within the housing.

FIG. 7a shows a lower part 16 and an upper part 18 of a housing. It can be seen that the lower part 16 and the upper part 18 are formed in a half-shell shape. In the housing parts 16, 18, recesses are provided, into which a cable can be inserted. The recesses lead into openings 20, which are only partially formed by the upper part 18 and the lower part 16 in the unjoined state and only combine to form a complete opening 20 in the joined state.

A connection according to FIG. 1 can be placed into a lower part 16, as shown in FIG. 7b. In this process, the sealing rings 8 are positioned directly in the region of the openings 20. The upper part 18 is then placed on the lower part 16.

FIG. 7c shows how the upper part 18 and the lower part 16 are joined to form a housing 22. The upper part 18 and the lower part 16 are integrally bonded to one another along a weld seam 24. The cable ends 2 and 4 protrude from the openings 20. The openings 20 are shaped so that they are sealed together with the sealing ring 8, as shown below.

FIG. 3 shows a plan view of a lower part 16, wherein the description may at least also partially apply to the upper part 18.

Firstly, it can be seen that the lower part 16 is shell-shaped and a sealing ring 8 is inserted in the region of the openings 20. The sealing ring 8, with its lamellae 14, rests on the inner lateral surface of the lower part 16. Protruding beyond an end face, a hard component 8″ is provided on the sealing ring 8. In longitudinal section, the hard component 8″ is U-shaped so that it encloses the outer lateral surface of the lower part 16. In the assembled state, the upper part 18 is placed on the lower part 16. The lamellae 14 are radially compressed inwards. The hard component 8″ is then pushed onto the opening in such a way that it encloses both the upper part and the lower part in the region of the opening 20 and secures them together. The cables are not shown in FIG. 3, but their insulation sheaths 2b, 4b rest against the inner lamellae 12 and elastically deform them radially outwards.

In the joined state, the sealing ring 8 is compressed and seals the opening 20 both on the inside of the housing and on the cable sheath.

A joining surface 24 is provided on the lower part 16. A complementary joining surface 24 is provided on the upper part 18.

FIG. 6a shows the two housing parts as upper part 18 and lower part 16 in a cross-section. A cross-section, including the cross-section generally described above, extends through the housing parts, i.e., also through the joining surfaces, preferably perpendicular to a longitudinal extension of the rib.

The upper part 18 has a joining surface 24a. The surface normal of the joining surface 24a is oriented perpendicular to the surface normal of the cross-sectional region shown, and thus perpendicular to an axis running in the plane of the drawing, which is parallel to a longitudinal extension of the upper part 18.

The lower part 16 has a joining surface 24b. The surface normal of the joining surface 24b is oriented perpendicular to the surface normal of the cross-sectional region shown, and thus perpendicular to an axis running in the plane of the drawing, which is parallel to a longitudinal extension of the lower part 16.

A rib 26 is arranged on the joining surface 24b. The longitudinal extension of the rib 26 is parallel to the surface normal of the cross-sectional region shown, parallel perpendicular to the axis running in the plane of the drawing.

The rib has two side walls 27a, b. The side wall 27a faces the interior of the housing. The side wall 27b faces the outside of the housing. In addition, the rib 26 has an end face 27c. The end face 27c runs parallel to the joining surface 24a.

As can be seen, the rib 26 is positioned off-center on the joining surface 24b. The rib 26 is offset towards the interior of the housing. However, it is also possible for the rib 26 to be offset towards the outside of the housing.

Furthermore, it can be seen that the joining surfaces 24a, b are located on outwardly projecting collars 44 of the two housing parts. The lower collar 44 on the part with the rib 26 makes it possible to apply a counterholder or stop. Against this counterholder, a hold-down device can then press with the contact force on the collar 44 of the upper part. The lower collar thus serves as a supporting surface for the counterholder. A further advantage is that the laser must only penetrate a smaller amount of material of the first part through the upper collar to reach the end face 27c of the rib 26.

To join the upper part 18 and the lower part 16, the joining surface 24a is aligned facing the joining surface 24b and placed on the end face 27c of the rib 26, as shown in FIG. 6b. Subsequently, the upper part is pressed against the lower part 16 with a holding-down device and a contact force in direction 32. The hold-down device can be pressed against the collar 44. The rib 26 forms a gap 34 between the upper part 18 and the lower part 16.

The upper part 18 is made of a material that exhibits lower opacity than the material of the lower part 16 and/or the material of the rib 26. As a result, a laser beam 30 can be guided through the material of the upper part 18 up to the joining surface 24. The laser beam 30 radiates through the upper part 18 and heats the materials of the lower part 16 and the upper part 18 at the joining surfaces 24a and 24b, in particular of the rib 26, and in this case, of the end face 27c, such that they melt. The region of melting is shown in black.

During the welding process, the two housing halves 16, 18 are moved towards each other under pressure so that they bond when the materials melt. As the materials melt, they flow into the gap 34, as shown in FIG. 6c.

FIG. 6c shows how molten material 36 has flowed into the gap 34. Due to the off-center arrangement of the rib 26, the material 36 preferentially flows in the direction of the inner wall of the housing. It can be seen that a bead 38 is formed on the inner lateral surface of the housing. In addition, material 36 also flows towards the outer wall of the housing. It is shown that the gap 34 between the joining surfaces 24a, b between the side wall 27a and the inner wall of the housing is completely filled with material 36. The gap 34 between the joining surfaces 24a, b can be partially [shown] or completely filled with material 36 between the side wall 27b and the outer wall of the housing.

The material 36 is formed from both the molten material of the rib 26 and of the upper part 18. After cooling, the molten material 36 solidifies, and the upper part 18 and the lower part 16 are joined together. Through the melting and pressing process, the rib 26 is compressed along a displacement path 42 towards the joining surface 24b. The bead 38 is completely enclosed by the lamellae 14 and thus the opening is sealed.

FIG. 4 shows a further exemplary embodiment in which the sealing ring 8 is fixed axially in the lower shell 16 at the opening 20 by means of two stops 40a, 40b. The sealing ring 8 can also be compressed axially by the stops 40a, b. In this case too, the sealing ring 8 provides a seal on the inner surface of the housing and also on the insulating sheaths in the manner described.

FIG. 5 shows a further exemplary embodiment in which a sealing ring 8 according to FIG. 2c is used. In contrast to the previous exemplary embodiments, the sealing of the sealing ring 8 on the inside of the housing is achieved via the radially outwardly projecting welding lug. Here, the welding lug can be welded to the inner surface of the lower shell 16 and the upper shell 18. In particular, a laser beam is directed onto the welding surface, causing the materials to melt so that they are integrally bonded after cooling.

The exemplary embodiments according to FIG. 3-5 differ only in the type of sealing rings 8. The insertion of the cables and the connection of the upper part 18 and the lower part 16 to one another in the manner shown in FIG. 6a and b, as well as in the manners generally described for this purpose, remain unchanged however.

FIG. 8 shows a further exemplary embodiment. It can be seen that the upper part 18 and the lower part 16 each have a collar 44 in the region of their outer edges. The collar 44 on the upper part forms the first joining surface 24a. This is preferably flat. The collar 44 on the lower part 16 forms the second joining surface 24b. The rib 26 runs along the joining surface 24b. The rib 26 extends along the side edge of the lower part 16.

It can be seen that the radial position of the rib 26 on the joining surface 24b is variable.

Preferably, the radial position of the rib 26 on the joining surface 24b is variable such that it is off-centered differently at various positions along the longitudinal axis of the joining surface 24b. In particular, the position of the rib 26 in the region of the opening is offset inwardly, off-center, as shown. Further along the rib, away from the opening 22, the position of the rib 26 on the joining surface 24b shifts. In particular, the position of the rib 26 in the region remote from the opening 18 is offset outwardly, off-center, as shown. In this region, the rib 26 is preferably positioned on the collar 44 of the lower part 16 and below the collar 44 of the upper part 18.

The trajectory of laser 30 is also shown. The laser 30 moves repeatedly radially offset along the longitudinal axis of the rib 26, as indicated by dashed lines.

The laser 30 traverses this trajectory within the shortest time, e.g. less than 10 s, preferably less than 5 s, preferably less than 1 s. In particular, the laser follows this trajectory in such a short time that already molten material of the rib 26 no longer solidifies. This allows the entire surface of the rib 26 to be melted and the upper part 18 can be welded to the lower part 16 along the rib 26 by applying pressure. In particular, the entire rib 26 is melted in this way. The laser irradiates the surface of the rib 26 quasi-simultaneously by repeatedly traversing and irradiating the longitudinal axis of the rib 26 in a radially offset manner. This takes place within a timeframe in which the molten material cannot solidify, so that a full-surface joint can be formed between the joining surface 24a and the end face of the rib 26.

### LIST OF REFERENCE SYMBOLS

2 main cable
4 branch cable
2a, 4a cable core
2, 4b insulating sheath
6 region
8 seal
8′ soft component
8″ hard component
8a outer circumference
8b inner width
10 longitudinal axis
12, 14 lamellae
16 lower part
18 upper part
20 opening
22 housing
24a, b joining surfaces
26 rib
27a, b side wall
27c end face
30 laser beam
32 direction
34 gap
36 material
38 bead
40a, b stop
42 displacement path
44 collar

1-31. (canceled)

32. A cable sealing housing comprising:
an at least two-part housing with an upper part and a lower part,
at least one opening formed as a cable-entry point in the housing,
wherein the upper part and the lower part each form part of the openings, wherein
when the housing is in the joined state, the mutually facing joining surfaces of the upper and lower parts have been laser-welded together,
wherein a first of the mutually facing joining surfaces is a substantially flat surface and that a second of the mutually facing joining surfaces comprises a rib protruding in the direction of the surface normal of this joining surface and
wherein, through laser welding, a region of the rib facing the first surface is melted and molten material from the rib at least partially fills a gap between the mutually facing joining surfaces.

33. The cable sealing housing according to claim 32, wherein, through laser welding, a region of the first surface directly abutting the rib is melted and molten material at least partially fills the gap between the mutually facing joining surfaces.

34. The cable sealing housing according to claim 33, wherein the molten material of the first surface and the molten material of the rib form an integral bond and at least partially fill the gap between the mutually facing joining surfaces.

35. The cable sealing housing according to claim 32, wherein the molten material fills the gap between the mutually facing joining surfaces in the region of an inner wall of the housing.

36. The cable sealing housing according to claim 32, wherein the displacement path of the rib caused by the laser welding is greater than 0.1 mm, preferably greater than 0.2 mm and less than 0.5 mm, preferably less than 0.4 mm.

37. The cable sealing housing according to claim 32, wherein
in a cross-section through the second joining surface, the rib is arranged off-center, in particular offset in the direction of an inner wall of the housing, in particular that a spacing from an inner side wall of the rib to an inner wall of the housing is smaller than a spacing from an outer side wall of the rib to an outer wall of the housing or
in a cross-section through the second joining surface the rib is arranged off-center, in particular offset in the direction of an outer wall of the housing, in particular that a spacing from an outer side wall of the rib to an outer wall of the housing is smaller than a spacing from an inner side wall of the rib to an inner wall of the housing.

38. The cable sealing housing according to claim 32, wherein the material melted by laser welding completely fills the gap between the housing parts, starting from the rib towards an inner wall of the housing, in particular that the molten material has a bead pointing into the interior of the housing.

39. The cable sealing housing according to claim 32, wherein within the housing at least one branch cable is connected, in particular as a splice, to a stripped center tap of a main cable and that the cable ends of the main cable extending from the center tap are led out of the housing through two openings and the at least one branch cable is led out of the housing through at least one third opening.

40. The cable sealing housing according to claim 32, further comprising at at least one of the openings, a sealing ring formed from at least one soft component is in abutment all around the insulation of the relevant cable and an inner surface of the relevant opening.

41. The cable sealing housing according to claim 32, wherein the upper part and the lower part are made of plastics with different opacities and preferably, the rib is made of a less opaque material than the material of the joining surface in abutment with the rib.

42. The cable sealing housing according to claim 32, wherein the rib is completely circumferential with the exception of at least one opening.

43. The cable sealing housing according to claim 32, wherein the rib is located in the region of the opening.

44. The cable sealing housing according to claim 32, wherein the hard component is formed on an outer circumference of the sealing ring with a radially outward-pointing projection and the projection is welded to the upper part and the lower part.

45. The cable sealing housing according to claim 32, wherein the hard component extends in the axial direction beyond the opening into a sealing section.

46. A method for producing a cable sealing housing comprising:
providing a first part and a second part of a housing with at least one opening formed as a cable-entry point in the housing, wherein the first part and the second part form an upper part and a lower part of the housing,
placing the two parts with mutually facing joining surfaces, wherein a first of the mutually facing joining surfaces is a flat surface and a second of the mutually facing joining surfaces comprises a rib protruding from a surface in the direction of the surface normal to this surface and
laser welding the first part to the second part along the abutting joining surfaces, wherein
during laser welding, a region of the rib facing the flat surface is melted and the molten material of the rib partially fills a gap between the mutually facing joining surfaces.
